(19) United States
(12) Patent Application Publication
(10) Pub. No.: US 2024/0242455 A1
(43) Pub. Date: Jul. 18, 2024

(54) STYLIZING ANIMATABLE HEAD AVATARS

(71) Applicant: Meta Platforms Technologies, LLC, Menlo Park, CA (US)

(72) Inventors: Albert Pumarola Peris, Kilchberg (CH); Thu Nguyen Phuoc, London (GB); Chen Cao, Pittsburgh, PA (US); Artsiom Sanakoyeu, Zurich (CH); Tao Xu, Sunnyvale, CA (US); Tomas Simon Kreuz, Pittsburgh, PA (US); Ali Thabet, Zurich (CH); Juan Camilo Perez, Paris (FR)

(21) Appl. No.: 18/411,615

(22) Filed: Jan. 12, 2024

Related U.S. Application Data
(60) Provisional application No. 63/479,976, filed on Jan. 13, 2023.

(51) Int. Cl. G06T 19/20; G06T 13/40

(52) U.S. Cl. CPC G06T 19/20; G06T 13/40; G06T 2219/2024

(57) ABSTRACT

As disclosed herein, a computer-implemented method is provided. In one aspect, the computer-implemented method may include receiving, from a client device, images of a user. The computer-implemented method may include determining a target appearance of an avatar of the user. The computer-implemented method may include generating, based on the images and the target appearance, renders of the avatar. The computer-implemented method may include determining, based on a difference between first and second renders, a first adjustment to a weight associated with a first parameter for generating the renders and a second adjustment to a weight associated with a second parameter for generating the renders. The computer-implemented method may include generating, based on the adjustments, a third render of the avatar, the third render appearing more similar to the target appearance relative to the first render and the second render. A system and a non-transitory computer-readable storage medium are also disclosed.

### CROSS-REFERENCE TO RELATED APPLICATIONS

The present application claims the benefit of priority under 35 U.S.C. § 119(e) from U.S. Provisional Patent Application Ser. No. 63/479,976 entitled “STYLIZING ANIMATABLE HEAD AVATARS,” filed on Jan. 13, 2023, the disclosure of which is hereby incorporated by reference in its entirety for all purposes.

### BACKGROUND

### Field

The present disclosure generally relates to virtual representations (e.g., avatars) of a real subject in a virtual environment. More particularly, the present disclosure relates to stylization of three-dimensional (3D) facial avatars by texture and geometry manipulations.

### Related Art

Augmented reality/virtual reality (AR/VR) technologies promise to preserve the realism of social presence across long distances. This promise of telepresence enables individuals to communicate from remote places, while maintaining a genuine feeling of mutual presence with other parties. Core to this idea is the ability to generate face avatars that are accurate in both appearance and animation of expression. Appearance accuracy, through photorealistic representations, ensures precise representation of face intricacies (e.g., facial hair, scars, tattoos, etc.), allowing individuals to accurately represent themselves in AR/VR environments. With animatable capabilities, avatars can further replicate an individual's expression with precision, thus providing a sense of realism and comfort to other parties with whom the individual interacts in the AR/VR environment. This option may be convenient in family reunions, work meetings, and other formal settings.

There are, however, situations in which individuals may prefer to present a different appearance. Given the limitless possibilities of a virtual world, individuals have a wide range of freedom of expression regarding their avatars. The possibilities allow an individual to present their real faces, a stylized version of their real face (e.g., with other textures), or a completely different face (e.g., the face of a dragon). This flexibility provides wider diversity of appealing experiences.

### SUMMARY

The subject disclosure provides for systems and methods for semantic stylization of animatable head avatars that disentangles geometry and texture manipulations and that stylizes the avatar by fine-tuning a subset of the weights of a model generating the avatar.

According to certain aspects of the present disclosure, a computer-implemented method is provided. The computer-implemented method may include receiving, from a client device, images of a user of the client device. The computer-implemented method may include determining a target appearance of an avatar of the user. The computer-implemented method may include generating, based on the images of the user and the target appearance of the avatar, renders of the avatar. The computer-implemented method may include determining, based on a difference between a first render and a second render of the renders, a first adjustment to a weight associated with a first parameter for generating the renders and a second adjustment to a weight associated with a second parameter for generating the renders. The computer-implemented method may include generating, based on the first adjustment and the second adjustment, a third render of the avatar, the third render appearing more similar to the target appearance relative to the first render and the second render.

According to another aspect of the present disclosure, a system is provided. The system may include one or more processors configured by machine-readable instructions. The processor(s) may be configured to receive, from a client device, images of a user of the client device. The processor(s) may be configured to determine a target appearance of an avatar of the user. The processor(s) may be configured to generate, based on the images of the user and based on the target appearance of the avatar, renders of the avatar. The processor(s) may be configured to determine, based on a difference between a first render and a second render of the renders, a first adjustment to a weight associated with a first parameter for generating the renders and a second adjustment to a weight associated with a second parameter for generating the renders. The processor(s) may be configured to generate, based on the first adjustment and the second adjustment, a third render of the avatar, the third render appearing more similar to the target appearance relative to the first render and the second render.

According to yet other aspects of the present disclosure, a non-transitory computer-readable storage medium having instructions embodied thereon, the instructions being executable by one or more processors to perform a method, is provided. The method may include receiving, from a client device, images of a user of the client device. The method may include determining a target appearance of an avatar of the user. The method may include generating, based on the images of the user and the target appearance of the avatar, renders of the avatar. The method may include determining, based on a difference between a first render and a second render of the renders, a first adjustment to a weight associated with a first parameter for generating the renders and a second adjustment to a weight associated with a second parameter for generating the renders. The method may include generating, based on the first adjustment and the second adjustment, a third render of the avatar, the third render appearing more similar to the target appearance relative to the first render and the second render.

It is understood that other configurations of the subject technology will become readily apparent to those skilled in the art from the following detailed description, wherein various configurations of the subject technology are shown and described by way of illustration. As will be realized, the subject technology is capable of other and different configurations and its several details are capable of modification in various other respects, all without departing from the scope of the subject technology. Accordingly, the drawings and detailed description are to be regarded as illustrative in nature and not as restrictive.

### BRIEF DESCRIPTION OF THE DRAWINGS

The accompanying drawings, which are included to provide further understanding and are incorporated in and constitute a part of this specification, illustrate disclosed embodiments and together with the description serve to explain the principles of the disclosed embodiments. In the drawings:

FIG. 1 illustrates a network architecture configured for semantic stylization of animatable head avatars, according to some embodiments;

FIG. 2 is a block diagram illustrating details of client devices and servers used in a network architecture as disclosed herein, according to some embodiments;

FIG. 3 illustrates an original head avatar and a series of stylized head avatars associated with the original head avatar, according to some embodiments;

FIG. 4 illustrates stylization across various identities and styles, according to some embodiments;

FIG. 5 is a block diagram illustrating an encoder-decoder model that may be used to generate an original head avatar and renders of stylized head avatars associated with the original head avatar, according to some embodiments;

FIG. 6 illustrates further detail of the block diagram shown in FIG. 5 by describing how geometry and texture may be disentangled to stylize a head avatar, according to some embodiments;

FIG. 7 illustrates the control of identity preservation, according to some embodiments;

FIG. 8 illustrates eye symmetry loss ablation, according to some embodiments;

FIG. 9 is a flowchart illustrating steps in a method for semantic stylization of animatable head avatars, according to some embodiments; and

FIG. 10 is a block diagram illustrating components in a computer system for performing methods as disclosed herein, according to some embodiments.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

The detailed description set forth below is intended as a description of various implementations and is not intended to represent the only implementations in which the subject technology may be practiced. As those skilled in the art would realize, the described implementations may be modified in various different ways, all without departing from the scope of the present disclosure. Accordingly, the drawings and description are to be regarded as illustrative in nature and not restrictive.

### General Remarks

Platforms aiming at offering meaningful AR/VR experiences should foster comfort for their users to express themselves via their avatars. This comfort may be supported by tools that empower casual users to customize their appearance without requiring technical knowledge. This last point may be imperative to ensure fair access to everyone. Progress may be already witnessed in photorealistic and animatable avatars, with momentous quality improvements in recent years. At present, there are avatars capable of preserving identity and realism across expressions, points of view, and lighting. Nonetheless, there remains a lack of automated capabilities to stylize and manipulate these representations.

A technical solution to this technical problem may be to directly stylize an avatar representation to fit a target style (or appearance). Such a technical problem may be addressed according to the methods and systems described herein. Given a model (e.g., a deep learning model) representing an avatar, geometry and texture manipulations or modifications may be disentangled; a loss between renders of the avatar and between embeddings of the target style may be computed; and the losses may be used to adjust the weights associated with the model to cause the avatar to appear more like the target style. By directly stylizing the avatar representation, in contrast to stylizing the renders of the avatar representation:
(i) stylization may be guided by images or text input or provided by a user, and may require no technical knowledge (i.e., may be easily used by casual users);
(ii) the animatable capabilities of an avatar may be preserved, providing consistent appearance across facial expressions and views;
(iii) fidelity to the identity of a person may be easily tuned, allowing soft and intense stylizations; and
(iv) consistent stylization capacity across styles and identities may be demonstrated.

Reference is now made to the drawings, wherein like reference numerals are used to refer to like elements throughout. In the following description, for purposes of explanation, numerous specific details are set forth in order to provide a thorough understanding thereof. It may be evident, however, that the novel embodiments may be practiced without these specific details. In other instances, well known structures and devices are shown in block diagram form in order to facilitate a description thereof. The intention is to cover all modifications, equivalents, and alternatives consistent with the claimed subject matter.

### Example System Architecture

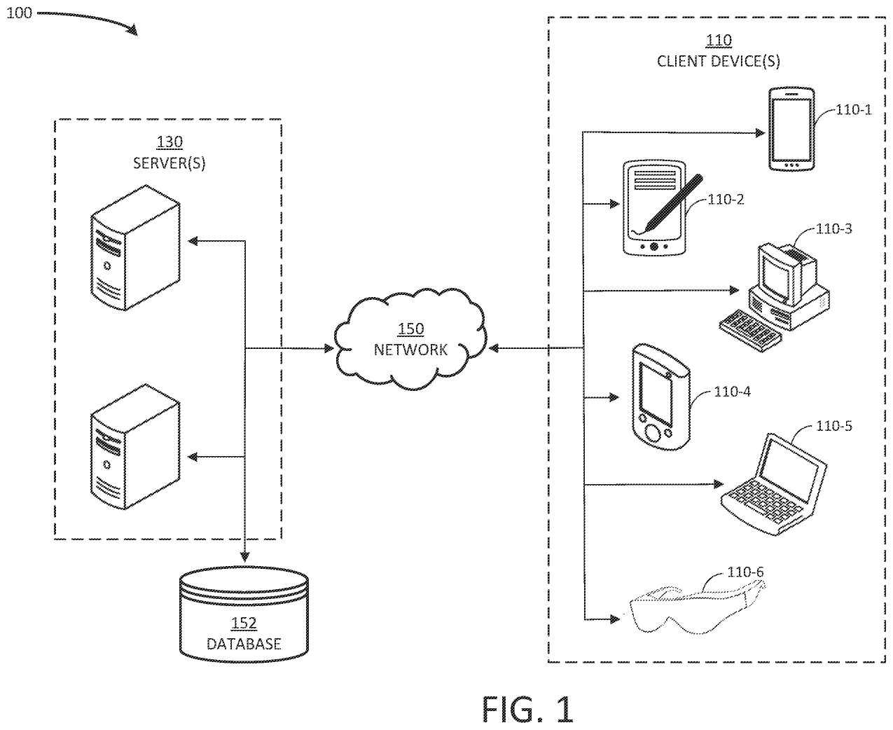

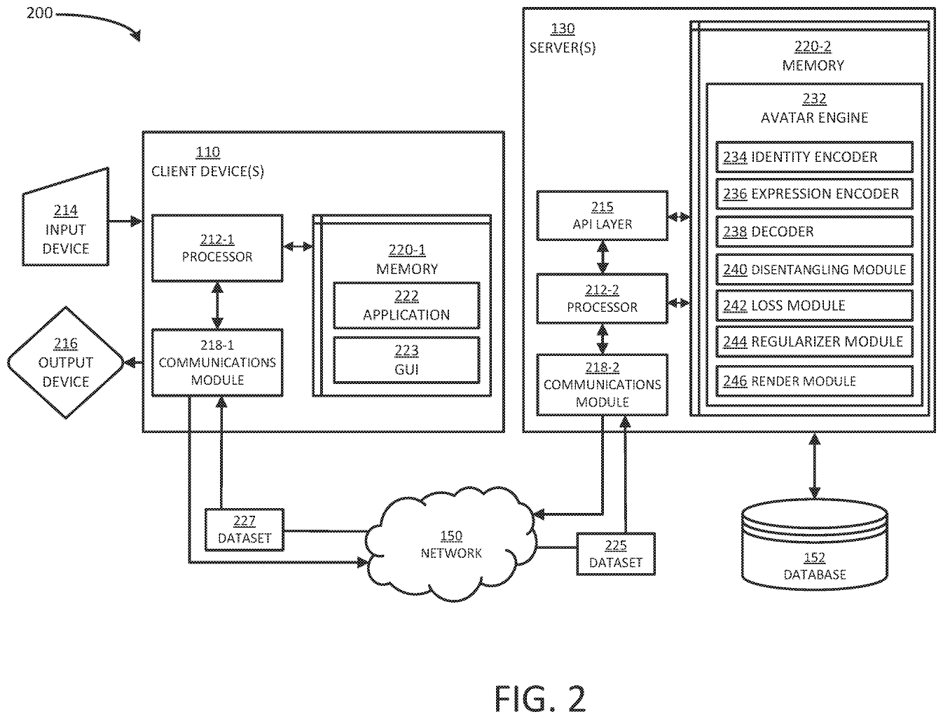

FIG. 1 illustrates a network architecture 100 configured for semantic stylization of animatable head avatars, according to some embodiments. Network architecture 100 may include servers 130 communicatively coupled with client devices 110 and at least one database 152 over a network 150. One of the many servers 130 may be configured to host a memory including instructions which, when executed by a processor, cause the servers 130 to perform at least some of the steps in methods as disclosed herein. In some embodiments, the processor may be configured to control a graphical user interface (GUI) for the user of one of client devices 110 accessing an avatar engine (e.g., avatar engine 232, FIG. 2) with an application (e.g., application 222, FIG. 2). Accordingly, the processor may include a dashboard tool, configured to display components and graphic results to the user via a GUI (e.g., GUI 223, FIG. 2). For purposes of load balancing, multiple servers 130 may host memories including instructions to one or more processors, and multiple servers 130 may host a history log and a database 152 including multiple training archives used for the avatar engine. Moreover, in some embodiments, multiple users of client devices 110 may access the same avatar engine to run one or more searches within a social network. In some embodiments, a single user with a single client device (e.g., one of client device 110) may provide images and data (e.g., text) to train one or more machine learning models running in parallel in one or more servers 130. Accordingly, client devices 110 and servers 130 may communicate with each other via network 150 and resources located therein, such as data in database 152.

Servers 130 may include any device having an appropriate processor, memory, and communications capability for hosting the avatar engine, including multiple tools associated with the avatar engine. The avatar engine may be accessible by client devices 110 over network 150.

Client devices 110 may include any one of a laptop computer 110-5, a desktop computer 110-3, or a mobile device such as a smartphone 110-1, a palm device 110-4, or a tablet device 110-2. In some embodiments, client devices 110 may include a headset or other wearable device 110-6 (e.g., a virtual reality headset, augmented reality headset, or smart glass), such that at least one participant may be running an immersive reality messaging application installed therein.

Network 150 may include, for example, any one or more of a local area network (LAN), a wide area network (WAN), the Internet, and the like. Further, network 150 may include, but is not limited to, any one or more of the following network topologies, including a bus network, a star network, a ring network, a mesh network, a star-bus network, tree or hierarchical network, and the like.

A user may own or operate a client device 110 that may include a smartphone device 110-1 (e.g., an iPhone® device, an Android® device, a Blackberry® device, or any other mobile computing device conforming to a smartphone form). Smartphone device 110-1 may be a cellular device capable of connecting to a network 150 via a cell system using cellular signals. In some embodiments and in some cases, smartphone device 110-1 may additionally or alternatively use Wi-Fi or other networking technologies to connect to the network 150. Smartphone device 110-1 may execute a messaging client, Web browser, or other local application to access the messaging server.

A user may own or operate a client device 110 that may include a tablet device 110-2 (e.g., an iPad® device, an Android® tablet device, a Kindle Fire® device, or any other mobile computing device conforming to a tablet form). Tablet device 110-2 may be a Wi-Fi device capable of connecting to a network 150 via a Wi-Fi access point using Wi-Fi signals. In some embodiments and in some cases, tablet device 110-2 may additionally or alternatively use cellular or other networking technologies to connect to the network 150. Tablet device 110-2 may execute a messaging client, Web browser, or other local application to access servers 130.

The user may own or operate a client device 110 that may include a personal computer device 110-5 (e.g., a Mac OS® device, Windows® device, Linux® device, or other computer device running another operating system). Personal computer device 110-5 may be an Ethernet device capable of connecting to a network 150 via an Ethernet connection. In some embodiments and in some cases, personal computer device 110-5 may additionally or alternatively use cellular, Wi-Fi, or other networking technologies to connect to the network 150. Personal computer device 110-5 may execute a messaging client, Web browser, or other local application to access servers 130.

A messaging client may be a dedicated messaging client. A dedicated messaging client may be specifically associated with a messaging provider administering a messaging platform, including messaging servers. A dedicated messaging client may be a general client operative to work with a plurality of different messaging providers including the messaging provider administering the messaging platform including the messaging servers.

Messaging interactions may use end-to-end encrypted communication between at least a sending client device (e.g., smartphone device 110-1), one or more back-end messaging servers (e.g., servers 130), and a receiving client device (e.g., desktop computer 110-3). A sending client device may encrypt an outgoing message using security techniques that establish one of only the receiving device being able to decrypt the outgoing message (e.g., by using public-key cryptography) or only the sending and receiving devices being able to decrypt the outgoing message (e.g., by using shared-key cryptography). In these embodiments, servers 130 of the messaging system may be prevented from decrypting messages being sent between client devices 110. However, in other embodiments, while encrypted communication may be used between client devices 110 and servers 130, servers 130 may be empowered to examine the contents of user messages. Such examination may be used to provide services to the users of the messaging system. In some embodiments, users may be empowered to select whether a particular message thread uses end-to-end encryption (and thereby receive the additional privacy of servers 130 being prevented from examining the contents of messages) or does not (and thereby receive the benefit of the messaging system being able to programmatically examine messages and offer relevant services to the users).

FIG. 2 is a block diagram 200 illustrating details of client devices 110 and servers 130 used in a network architecture as disclosed herein (e.g., network architecture 100), according to some embodiments. Client devices 110 and servers 130 may be communicatively coupled over network 150 via respective communications modules 218-1 and 218-2 (hereinafter, collectively referred to as “communications modules 218”). Communications modules 218 may be configured to interface with network 150 to send and receive information, such as requests, responses, messages, and commands to other devices on the network in the form of datasets 225 and 227. Communications modules 218 may be, for example, modems or Ethernet cards, and may include radio hardware and software for wireless communications (e.g., via electromagnetic radiation, such as radiofrequency (RF), near field communications (NFC), Wi-Fi, or Bluetooth radio technology). Client devices 110 may be coupled with an input device 214 and with an output device 216. Input device 214 may include a keyboard, a mouse, a pointer, a touchscreen, a microphone, a joystick, a virtual joystick, and the like. In some embodiments, input device 214 may include cameras, microphones, and sensors, such as touch sensors, acoustic sensors, inertial motion units (IMUs), and other sensors configured to provide input data to an AR/VR headset. For example, in some embodiments, input device 214 may include an eye-tracking device to detect the position of a pupil of a user in an AR/VR headset. Likewise, output device 216 may include a display and a speaker with which the customer may retrieve results from a client device 110. A client device 110 may also include a processor 212-1, configured to execute instructions stored in a memory 220-1, and to cause a client device 110 to perform at least some of the steps in methods consistent with the present disclosure. Memory 220-1 may further include an application 222 and a GUI 223, configured to run in a client device 110 and couple with input device 214 and output device 216. Application 222 may be downloaded by the user from servers 130 and may be hosted by servers 130. In some embodiments, client device 110 may be an AR/VR headset and application 222 may be an immersive reality application. In some embodiments, a client device 110 may be a mobile phone used to collect a video or picture and upload to servers 130 using a video or image collection application (e.g., application 222), to store in database 152. In some embodiments, application 222 runs on any operating system (OS) installed in a client device 110. In some embodiments, application 222 may run out of a Web browser, installed in a client device 110.

Dataset 227 may include multiple messages and multimedia files. A user of a client device 110 may store at least some of the messages and data content in dataset 227 in memory 220-1. In some embodiments, a participant may upload, with a client device 110, a dataset 225 onto servers 130, as part of a messaging interaction (or conversation). Accordingly, dataset 225 may include a message from the participant, or a multimedia file that the participant wants to share in a conversation.

A database 152 may store data and files associated with a conversation from application 222 (e.g., one or more of datasets 225 and 227).

Servers 130 may include an application programming interface (API) layer 215, which may control application 222 in each of client devices 110. Servers 130 may also include a memory 220-2 storing instructions which, when executed by a processor 212-2, cause servers 130 to perform at least partially one or more operations in methods consistent with the present disclosure.

Processors 212-1 and 212-2, and memories 220-1 and 220-2 will be collectively referred to, hereinafter, as “processors 212” and “memories 220,” respectively.

Processors 212 may be configured to execute instructions stored in memories 220. In some embodiments, memory 220-2 may include an avatar engine 232. Avatar engine 232 may share or provide features and resources to GUI 223, including multiple tools associated with stylization, personalization, and animation, or design applications that use avatars retrieved with avatar engine 232 (e.g., application 222). A user may access avatar engine 232 through application 222, installed in a memory 220-1 of a client device 110. Accordingly, application 222, including GUI 223, may be installed by servers 130 and perform scripts and other routines provided by servers 130 through any one of multiple tools. Execution of application 222 may be controlled by processor 212-1.

Memory 220-2 may include avatar engine 232. Avatar engine 232 may include identity encoder 234, expression encoder 236, decoder 238, disentangling module 240, loss module 242, regularizer module 244, and render module 246. Avatar engine 232 may generate a three-dimensional (3D) mesh that forms a solid model of a subject (e.g., avatar) based on captured images or stylistic representations of the subject. The stylistic representation may be hand drawings or computer-generated drawings of different views of a subject from different directions. Avatar engine 232 may determine, or classify, a target style (or appearance) for an avatar. Identity encoder 234 may extract and encode from image data identity-related features of a user. Identity encoder 234 may determine the identification features of an avatar that provide a unique identity to a model for generating the avatar. Identity encoder 234, for example, may identify that a certain user furrows some areas in the face for a generic laughter expression. Expression encoder 236 may extract and encode from image data expression-related features of a user. Expression encoder 236 may incorporate a facial expression onto an avatar. In some embodiments, there may be a selected number of expressions that may be handled, stored in database 152. Decoder 238 may decode an encoding of identity related features and expression-related features, and decoder 238 may translate such an encoding into audio and visual signals that may be viewed as a representation of the identity and expression of a user. Disentangling module 240 may separate the geometry inputs and the texture inputs that may have been combined at several stages by a model (e.g., a deep learning model) to generate an avatar. Loss module 242 may compute a loss between renders of an avatar and embeddings of a target style (or appearance). Regularizer module 244 may determine or apply two regularizers: the first, to control identity preservation in an avatar; the second, to control asymmetrical artifacts in the avatar. Render module 246 may transform a decoding of identity-related data and expression-related data into a perceptible output (e.g., via GUI 223).

In some embodiments, avatar engine 232 may include a neural network tool that may train identity encoder 234, expression encoder 236, decoder 238, disentangling module 240, loss module 242, regularizer module 244, or render module 246 to stylize avatars for application 222. The neural network tool may be part of one or more machine learning models stored in a database 152. Database 152 may include training archives and other data files that may be used by avatar engine 232 in the training of a machine learning model, according to the input of the user through application 222. Moreover, in some embodiments, at least one or more training archives or machine learning models may be stored in either one of memories 220, and the user may have access to them through application 222.

The neural network tool may include algorithms trained for the specific purposes of the engines and tools included therein. The algorithms may include machine learning or artificial intelligence algorithms making use of any linear or non-linear algorithm, such as a neural network algorithm, or multivariate regression algorithm. In some embodiments, the machine learning model may include a neural network (NN), a convolutional neural network (CNN), a generative adversarial neural network (GAN), a deep reinforcement learning (DRL) algorithm, a deep recurrent neural network (DRNN), a classic machine learning algorithm, such as random forest, k-nearest neighbor (KNN) algorithm, k-means clustering algorithms, or any combination thereof. More generally, the machine learning model may include any machine learning model involving a training step and an optimization step. In some embodiments, database 152 may include a training archive to modify coefficients according to a desired outcome of the machine learning model. Accordingly, in some embodiments, avatar engine 232 may be configured to access database 152 to retrieve documents and archives as inputs for the machine learning model. In some embodiments, avatar engine 232, the tools contained therein, and at least part of database 152 may be hosted in a different server that is accessible by servers 130 or client devices 110.

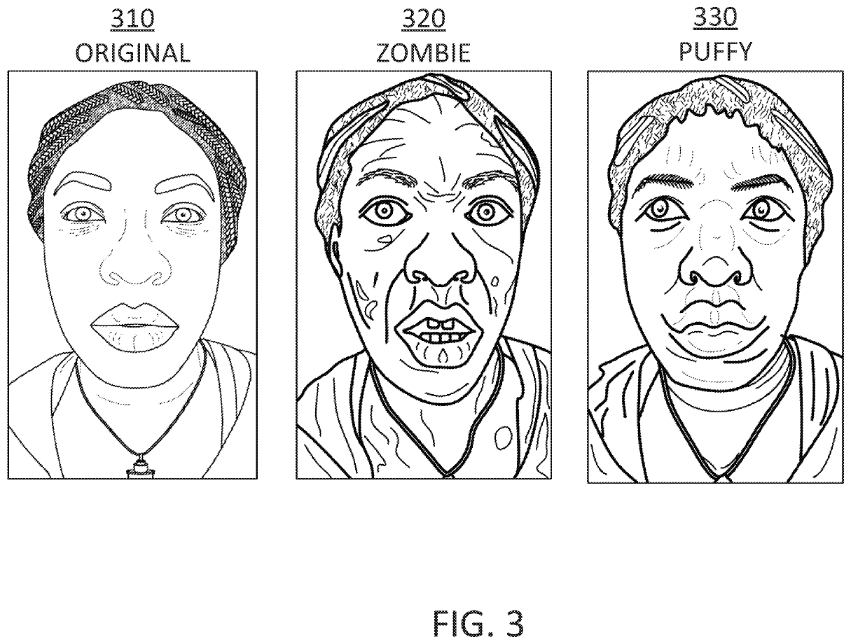

FIG. 3 illustrates Original head avatar 310 and two stylized head avatars (Zombie 320 and Puffy 330) associated with Original head avatar 310, according to some embodiments. In some embodiments, an avatar (e.g., 310, 320, and 330) may be represented by a model (e.g., a deep learning model) that maps the appearance of a person, described by texture and geometry, to a volumetric representation that allows rendering the avatar from novel views. An avatar may further account for facial expressions by conditioning a model on features that encode such expressions.

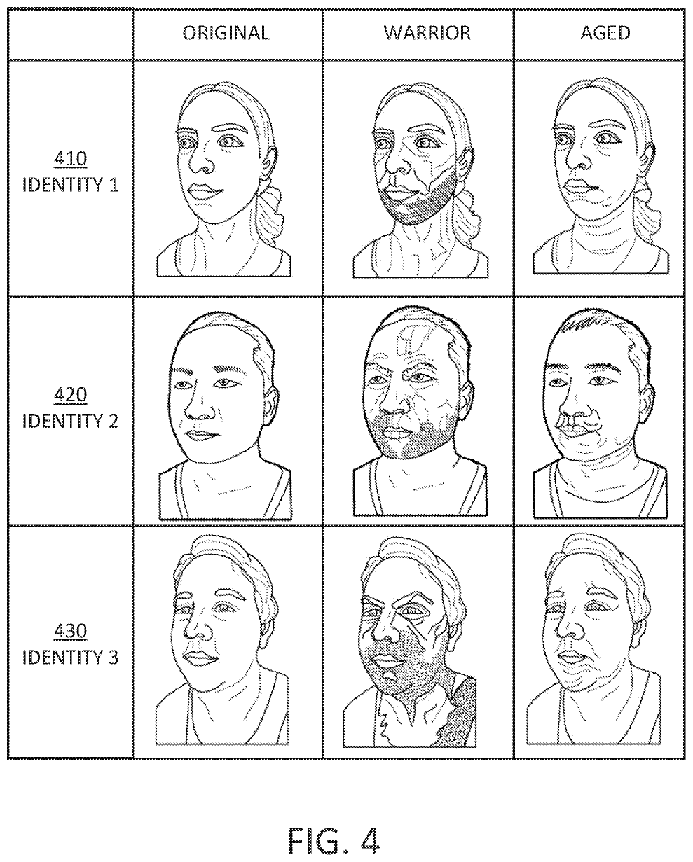

FIG. 4 illustrates stylization across various identities (including Identity 1 (410), Identity 2 (420), and Identity 3 (430)) and styles (including Warrior and Aged), according to some embodiments. As may be noted in FIG. 4, key facial features of a real subject of an avatar (e.g., face shape, nose structure, and lip shape) are preserved, while introducing changes to the appearances of the avatars based on target styles. For example, stylization based on the target style Warrior adds facial hair and a scowl to the avatars, and stylization based on the target style Aged adds eye wrinkles and skin sagging to the avatars.

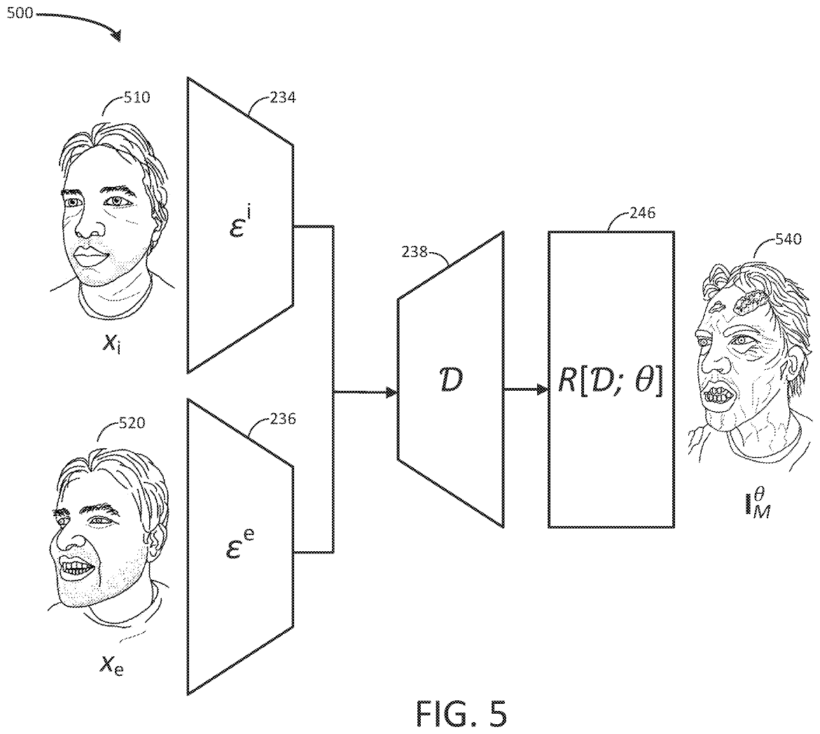

FIG. 5 is a block diagram illustrating an encoder-decoder model 500 that may be used to generate an original head avatar (e.g., Original head avatar 310) and renders of stylized head avatars (e.g., Zombie 320 and Puffy 330) associated with the original head avatar, according to some embodiments. Encoder-decoder model 500 includes identity encoder 234, expression encoder 236, decoder 238, and render module 246. In some embodiments, an identity of an avatar produced by the model may be defined by the specific weights of the model; meaning, each user may have their own unique weights.

The inputs to the model may be an identity—i.e., the appearance of a person-denoted by xᵢ (e.g., identity 510) and an expression, denoted by xₑ (e.g., expression 520). Both xᵢ and xₑ may be pairs of a position map representing a mesh and a texture representing color appearance. The identity-expression inputs may be mapped to an avatar of a given identity exhibiting the specified expression. In some embodiments, identity xᵢ and expression xₑ may be separately processed by two independent encoders: identity xᵢ by encoder εⁱ; and expression xₑ by encoder ε^{e}. The outputs of encoder εⁱ and encoder ε^{e} may be processed by decoder D to generate the avatar. Accordingly, the renderable outputs of the model may be M(xᵢ, xₑ)=D(εⁱ(xᵢ), ε^{e}(xₑ)). By defining θ as a set of camera parameters and R[·; θ] as a rendering operator conditioned on θ, a rendered image I_{M}^{θ} (e.g., render 540) of the avatar with model M may be defined as:

$${I}_{M}^{θ} = R [ M ( {x}_{i} , {x}_{e} ) ; θ ] = R [ 𝒟 ( {ε}^{i} ( {x}_{i} ) , {ε}^{e} ( {x}_{e} ) ) ; θ ] \qquad Equation ( 1 )$$

According to this framework, manipulating the appearance of an avatar may amount to manipulating the components that are associated with the identity of the avatar. In some embodiments, an avatar may be stylized by manipulating the identity of the avatar, wherein manipulating the identity of the avatar may include manipulating one or more of the modules of M, corresponding to both identity encoder εⁱ (234) and decoder D (238), while leaving expression encoder ε^{e} (236) fixed.

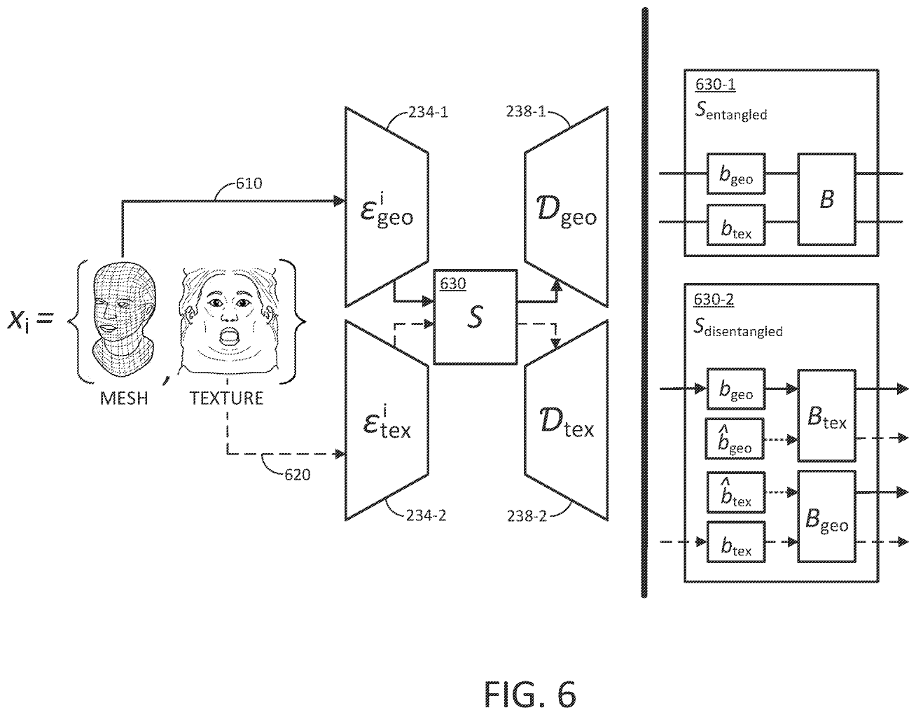

FIG. 6 illustrates further detail of the block diagram shown in FIG. 5 by describing how geometry and texture may be disentangled to stylize a head avatar, according to some embodiments. In FIG. 6, identity xᵢ is represented as a mesh and a texture map. The mesh may be processed by the geometry processing branch 610 (the solid line), and the texture map may be processed by the texture processing branch 620 (the dashed line). The branches may connect identity encoders ε_{geo}ⁱ (234-1) and εₜₑₓⁱ (234-2) and decoders D_{geo} (238-1) and Dₜₑₓ (238-2) by a set of skip connections S (630).

Face identity may traditionally be described by two factors: texture and geometry. In some embodiments, an identity manipulation may include manipulating texture and geometry, wherein both factors may be decisive for appearance. In some embodiments, a model (e.g., encoder-decoder model 500) used to generate an original head avatar (e.g., 310) and renders of stylized head avatars (e.g., 320 and 330) may combine texture inputs and geometry inputs at several stages in a forward pass to produce realistic results. Therefore, modifying identity encoder εⁱ (234) and decoder D (238) may result in entangled edits of the texture and geometry of an avatar (e.g., S_{entangled} (630-1)).

It may be noted from FIG. 6 that identity encoder εⁱ (234), where εⁱ={ε_{geo}ⁱ, εₜₑₓⁱ}, and the decoder D (238), where D={D_{geo}, Dₜₑₓ}, are internally divided into geometry processing branch 610 and texture processing branch 620. The branches inherit the names of the inputs received by their encoders: identity encoder ε_{geo}ⁱ (234-1) receives a position map (representing a mesh); identity encoder εₜₑₓⁱ (234-2) receives a texture map. Under this configuration, geometry processing branch 610 may include {εgeo, D_{geo}}, and texture processing branch 620 may include {εₜₑₓⁱ>Dₜₑₓ}. The branches may connect identity encoders ε_{geo}ⁱ (234-1) and εₜₑₓⁱ (234-2) and decoders D_{geo} (238-1) and Dₜₑₓ (238-2) by a set of skip connections S (630). Skip connections S (630) may connect the forward passes of geometry processing branch 610 and texture processing branch 620 via bias layer B (top-right) under the configuration S_{entangled} (630-1), wherein geometry and texture may be entangled.

In some embodiments, skip connections S (630) may be modified. It may be noted from FIG. 5 that inside skip connections S_{entangled} (630-1), bias layer B receives geometry and texture features as inputs (i.e., b_{geo} and bₜₑₓ), and feeds the output to D_{geo} (238-1) and Dₜₑₓ (238-2). To prevent this connection during optimization of a stylized avatar, initial values for b_{geo} and bₜₑₓ may be frozen (denoted, respectively, as b_{geo} and bₜₑₓ) in skip connections S_{disentangled} (630-2). Further, bias layer B may be split into two layers, B_{geo} and Bₜₑₓ, whose corresponding inputs may be kept fixed during optimization of a stylized avatar. With these modifications, geometry and texture may be independently edited by adjusting the corresponding encoder-decoder weights. That is, geometry may be controlled by modifying {ε_{geo}ⁱ, D_{geo}}, and texture may be controlled by modifying {εₜₑₓⁱ, Dₜₑₓ}.

According to some embodiments, a loss may be computed between renders of an avatar and embeddings of a target style. The loss may be used to adjust identity encoder εᵢ (234) and decoder D (238) to generate a stylized avatar that represents or appears perceptibly similar to the target style. In some embodiments, the loss may be a directional loss, wherein the directional loss may be designed to adjust a model generating an avatar from a source domain to a target domain by causing the model to “slide” away from the source (or original) avatar along a particular direction. The adjustment process may use a frozen copy of the original model throughout optimization. Specifically, an optimized model may be encouraged to generate images that differ from those generated by the frozen model only along a specified target direction in the embedding space of the model, which may be achieved by enforcing the optimized images to follow a direction parallel to the given target direction.

In some embodiments, the loss may be leveraged to adjust or improve a disentangled architecture as described above. The model generating the avatar may be used to process text and renders of the avatar and to freeze a copy of avatar model M throughout optimization. The target embedding space direction, d_{tgt}=e_{tgt}−e_{src}, may be given by the embeddings e_{src} and e_{tgt} describing, respectively, the source and the target styles. The optimized direction may be computed between embeddings of renders of the avatar being stylized, I_{M+}, and the original avatar, I_{M}. The stylization loss may be given as follows:

$${L}_{sty} ( {M}^{*} , M ) = {D}_{cos} ( f ( {I}_{{M}^{*}}^{θ} ) - f ( {I}_{M}^{θ} ) , {d}_{t g t} ) , \qquad Equation ( 2 )$$

where D_{cos} may be the cosine distance; M* and M may denote stylized and frozen avatar models, respectively; and f(·) may be the image encoder. Guiding stylization based on text or images may be reduced to how e_{tgt} and e_{src} are computed. That is, for text guidance, e_{tgt} and e_{src} may be text embeddings with template augmentations, and for image guidance, e_{tgt} may be the embedding of the target style images, and e_{src} may be an embedding of a render of the original avatar.

According to some embodiments, two regularizers may be used for stylization: the first, identity regularizer λ_{id} to control identity; the second, symmetry regularizer λ_{sym} to control asymmetrical artifacts in an avatar. In some embodiments, identity regularizer λ_{id} may include an image-structure regularizer that may preserve at least one of spatial layout, shape, and perceived semantics between two images, and so serve as a proxy for facial features and structure. The regularizer may operate on self-similarity matrices of the features of an image. In some embodiments, by defining fⁱ(·) as the i^{th} token, the entries of the self-similarity matrix may be given by the following:

$${S ( I )}_{i , j} = 1 - {D}_{cos} ( {f}^{i} ( I ) , {f}^{j} ( I ) ) . \qquad Equation ( 3 )$$

The identity regularizer λ_{id} may then be defined as the Frobenius norm between the self-similarity matrices. Formally, an identity loss may be defined as follows:

$${L}_{i d} ( {M}^{*} , M ) = {‖ S ( {I}_{{M}^{*}}^{θ} ) - S ( {I}_{M}^{θ} ) ‖}_{F} . \qquad Equation ( 4 )$$

According to some embodiments, some styles may introduce undesirable asymmetrical artifacts in avatars. In some embodiments, a symmetry regularizer λ_{sym} that targets asymmetrical artifacts around the eyes of an avatar may include a structural similarity (SSIM) index loss that compares two eyes from a frontal view. By defining θ as a set of camera parameters corresponding to a frontal view of the avatar, the symmetry loss may be defined as follows:

$${L}_{s y m} ( {M}^{*} ) = SSIM ( {eye}_{L} ( {I}_{{M}^{*}}^{θ} ) , {eye}_{R} ( {I}_{{M}^{*}}^{θ} ) ) , \qquad Equation ( 5 )$$

wherein the extraction of the eye region, including a left eye (eye_{L}) and a right eye (eye_{R}) may be enabled by the direct control over the avatar and its renders described throughout the disclosure. As such, the process of the extraction of the eye region may be independent of additional face-parsing pipelines.

Overall, the objective for stylization may be defined as follows:

$$arg {min}_{{M}^{*}} {E}_{θ , {x}_{e}} [ {L}_{sty} + {λ}_{i d} {L}_{i d} + {λ}_{s y m} {L}_{s y m} ] , \qquad Equation ( 6 )$$

wherein the expected value E is taken over camera parameters θ and facial expressions xₑ from Equation (1).

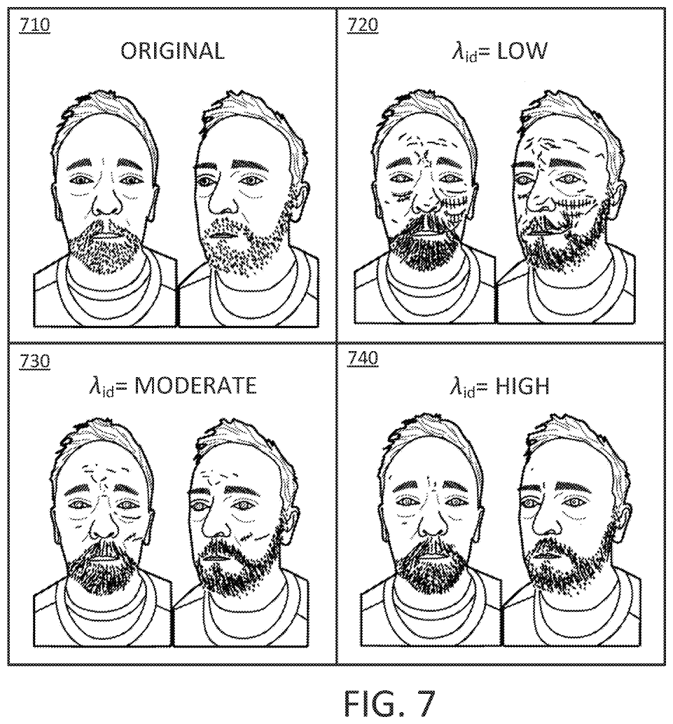

FIG. 7 illustrates the control of identity preservation, according to some embodiments. In FIG. 7, two views, a front view and a perspective view of an avatar are shown, including the original (or source) avatar 710 and three stylized versions of the avatar, using a “monster” target style, with low identity regularization (e.g., λ_{id}=0.0; stylization 720), with high identity regularization (e.g., λ_{id}=20.0; stylization 740), and with moderate identity regularization (e.g., λ_{id}=10.0; stylization 730). For low identity regularization (stylization 720), the figure shows the result may be dramatic appearance changes that may hinder recognition of the owner or user associated with the avatar (e.g., heavy facial hair, deep brow furrows, and prominent scars, relative to the original avatar). For high identity regularization (stylization 740), the figure shows the result may be that a person may be easily distinguished but the stylization strength may be compromised such that the stylization may not be easily perceived. For moderate identity regularization (stylization 730), the figure shows a balance may be maintained between stylization and identity preservation. For example, stylization 730 maintains the jaw and cheek structure of original avatar 710 and perceptibly incorporates “monster” scarring and skin texture.

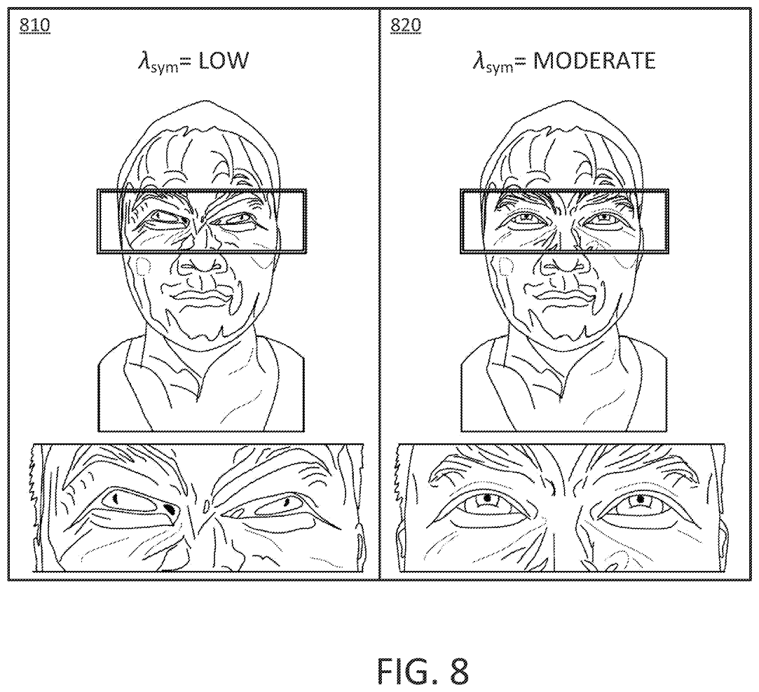

FIG. 8 illustrates eye symmetry loss ablation, according to some embodiments. Symmetry regularizer λ_{sym} may prevent stylization from sporadically introducing undesirable artifacts in the eyes of the avatar. Such undesirable artifacts may strongly affect the appearance of the avatar and may have even stronger consequences when animating, i.e., driving, the avatar. As shown for stylization 810, when the symmetry regularizer is set at a low value (e.g., λ_{sym}=0.0), the eyes may be distorted such that no pupil may be discerned. As shown for stylization 820, when the symmetry regularizer is set at a moderate value (e.g., λ_{sym}=0.5), the shape of the eyes may be maintained.

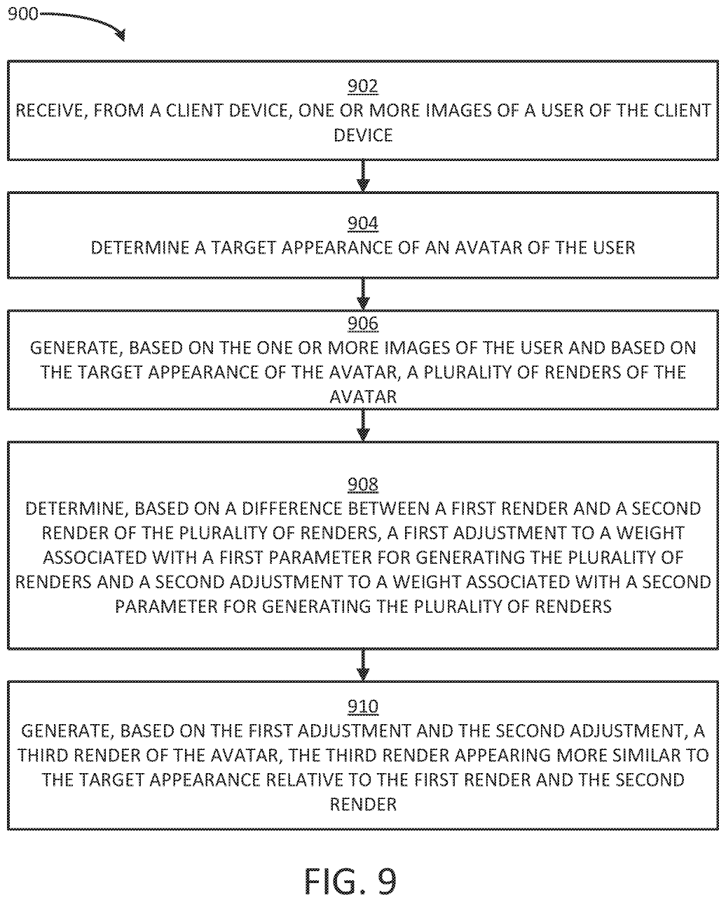

FIG. 9 is a flowchart illustrating steps in a method 900 for semantic stylization of animatable head avatars, according to some embodiments. In some embodiments, methods as disclosed herein may include one or more steps in method 900 performed by a processor circuit executing instructions stored in a memory circuit, in a client device, a remote server or a database, communicatively coupled through a network (e.g., processors 212, memories 220, client devices 110, servers 130, database 152, and network 150). In some embodiments, one or more of the steps in method 900 may be performed by an avatar engine, including an identity encoder, expression encoder, decoder, disentangling module, loss module, regularizer module, and render module, as disclosed herein (e.g., avatar engine 232, including identity encoder 234, expression encoder 236, decoder 238, disentangling module 240, loss module 242, regularizer module 244, and render module 246). In some embodiments, methods consistent with the present disclosure may include at least one or more steps as in method 900 performed in a different order, simultaneously, quasi-simultaneously, or overlapping in time.

Step 902 includes receiving, from a client device, one or more images of a user of the client device. In some embodiments, a user may capture images using an input device (e.g., input device 214) of the client device. The images may include images of the head or body of a user. In some embodiments, Step 902 further includes extracting, from the one or more images of the user, a face or head of the user. In some embodiments, Step 902 further includes generating, from the one or more images of the user, the avatar of the user. In some embodiments, the avatar of the user may be a photorealistic avatar that may be used as a source or original avatar for stylization according to a target style.

Step 904 includes determining a target appearance of an avatar of the user. In some embodiments, Step 904 further includes receiving, from a client device, the target appearance by at least one of text and images. In such an embodiment, a user may input text associated with a target appearance (e.g., “Make my avatar look like a clown”; “I want to look like my favorite superhero”; “zombie”; “manga”), or a user may input an image (e.g., a photo or a drawing) associated with a target appearance (e.g., a photo of a pet cat).

Step 906 includes generating, based on the one or more images of the user and based on the target appearance of the avatar, a plurality of renders of the avatar.

Step 908 includes determining, based on a difference between a first render and a second render of the plurality of renders, a first adjustment to a weight associated with a first parameter for generating the plurality of renders and a second adjustment to a weight associated with a second parameter for generating the plurality of renders. In some embodiments, the first parameter may include a geometry parameter and the second parameter may include a texture parameter. In some embodiments, Step 908 may further include determining, based on a loss, the difference between the first render and the second render of the plurality of renders. In some embodiments, the loss may include a direction loss between a source domain associated with an original render of the avatar and a target domain associated with the target appearance of the avatar. In some embodiments, the plurality of renders may differ from the original render only along a target direction from the source domain to the target domain. In some embodiments, Step 908 may further include determining a regularizer to preserve one or more key facial features of the user between the first render and the second render. In some embodiments, the regularizer may preserve at least one of spatial layout, shape, and perceived semantics between the first render and the second render. In some embodiments, Step 908 may further include determining a regularizer to reduce asymmetrical artifacts around eyes of the avatar between the first render and the second render. In some embodiments, the loss may include a stylization loss, an identity loss, and a symmetry loss.

Step 910 includes generating, based on the first adjustment and the second adjustment, a third render of the avatar, the third render appearing more similar to the target appearance relative to the first render and the second render.

### Hardware Overview

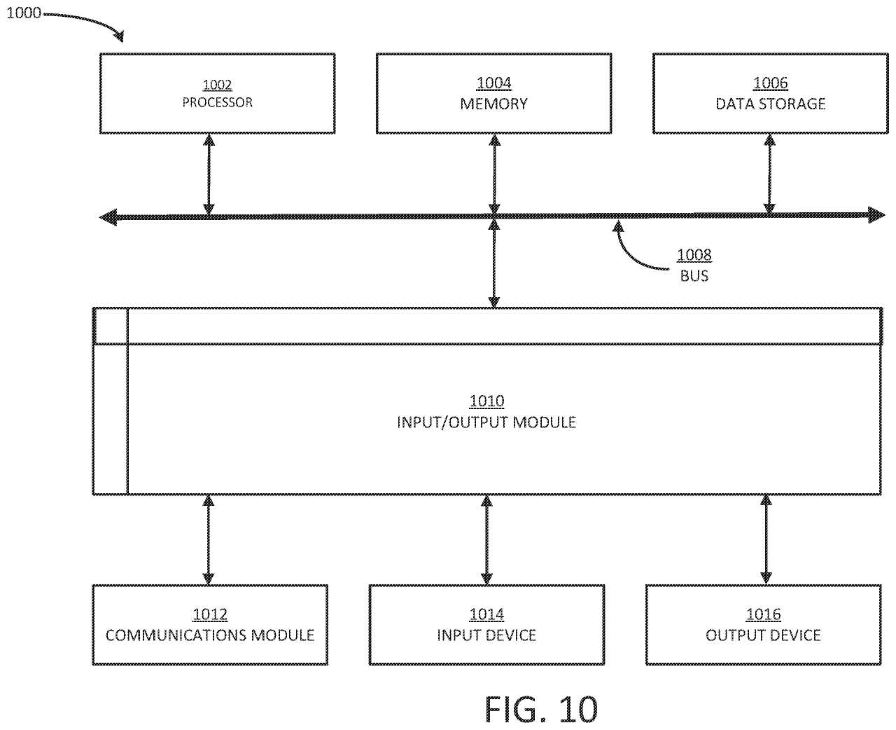

FIG. 10 is a block diagram illustrating an exemplary computer system 1000 with which mobile phones and other client devices, and the methods in FIG. 9, may be implemented, according to some embodiments. In certain aspects, the computer system 1000 may be implemented using hardware or a combination of software and hardware, either in a dedicated server, or integrated into another entity, or distributed across multiple entities.

Computer system 1000 (e.g., client devices 110 and servers 130) includes a bus 1008 or other communication mechanism for communicating information, and a processor 1002 (e.g., processors 212) coupled with bus 1008 for processing information. By way of example, the computer system 1000 may be implemented with one or more processors 1002. Processor 1002 may be a general-purpose microprocessor, a microcontroller, a Digital Signal Processor (DSP), an Application Specific Integrated Circuit (ASIC), a Field Programmable Gate Array (FPGA), a Programmable Logic Device (PLD), a controller, a state machine, gated logic, discrete hardware components, or any other suitable entity that may perform calculations or other manipulations of information.

Computer system 1000 may include, in addition to hardware, code that creates an execution environment for the computer program in question, e.g., code that constitutes processor firmware, a protocol stack, a database management system, an operating system, or a combination of one or more of them stored in an included memory 1004 (e.g., memories 220), such as a Random Access Memory (RAM), a flash memory, a Read-Only Memory (ROM), a Programmable Read-Only Memory (PROM), an Erasable PROM (EPROM), registers, a hard disk, a removable disk, a CD-ROM, a DVD, or any other suitable storage device, coupled to bus 1008 for storing information and instructions to be executed by processor 1002. The processor 1002 and the memory 1004 may be supplemented by, or incorporated in, special purpose logic circuitry.

The instructions may be stored in the memory 1004 and implemented in one or more computer program products, e.g., one or more modules of computer program instructions encoded on a computer-readable medium for execution by, or to control the operation of, the computer system 1000, and according to any method well-known to those of skill in the art, including, but not limited to, computer languages such as data-oriented languages (e.g., SQL, dBase), system languages (e.g., C, Objective-C, C++, Assembly), architectural languages (e.g., Java, .NET), and application languages (e.g., PHP, Ruby, Perl, Python). Instructions may also be implemented in computer languages such as array languages, aspect-oriented languages, assembly languages, authoring languages, command line interface languages, compiled languages, concurrent languages, curly-bracket languages, dataflow languages, data-structured languages, declarative languages, esoteric languages, extension languages, fourth-generation languages, functional languages, interactive mode languages, interpreted languages, iterative languages, list-based languages, little languages, logic-based languages, machine languages, macro languages, metaprogramming languages, multiparadigm languages, numerical analysis, non-English-based languages, object-oriented class-based languages, object-oriented prototype-based languages, off-side rule languages, procedural languages, reflective languages, rule-based languages, scripting languages, stack-based languages, synchronous languages, syntax handling languages, visual languages, wirth languages, and xml-based languages. Memory 1004 may also be used for storing temporary variable or other intermediate information during execution of instructions to be executed by processor 1002.

A computer program as discussed herein does not necessarily correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, subprograms, or portions of code). A computer program may be deployed to be executed on one computer or on multiple computers that may be located at one site or distributed across multiple sites and interconnected by a communication network. The processes and logic flows described in this specification may be performed by one or more programmable processors executing one or more computer programs to perform functions by operating on input data and generating output.

Computer system 1000 further includes a data storage device 1006 such as a magnetic disk or optical disk, coupled to bus 1008 for storing information and instructions. Computer system 1000 may be coupled via input/output module 1010 to various devices. Input/output module 1010 may be any input/output module. Exemplary input/output modules 1010 include data ports such as Universal Serial Bus (USB) ports. The input/output module 1010 may be configured to connect to a communications module 1012. Exemplary communications modules 1012 (e.g., communications modules 218) include networking interface cards, such as Ethernet cards and modems. In certain aspects, input/output module 1010 may be configured to connect to a plurality of devices, such as an input device 1014 (e.g., input device 214) and/or an output device 1016 (e.g., output device 216). Exemplary input devices 1014 include a keyboard and a pointing device, e.g., a mouse or a trackball, by which a user may provide input to the computer system 1000. Other kinds of input devices 1014 may be used to provide for interaction with a user as well, such as a tactile input device, visual input device, audio input device, or brain-computer interface device. For example, feedback provided to the user may be any form of sensory feedback, e.g., visual feedback, auditory feedback, or tactile feedback; and input from the user may be received in any form, including acoustic, speech, tactile, or brain wave input. Exemplary output devices 1016 include display devices, such as an LCD (liquid crystal display) monitor, for displaying information to the user.

According to one aspect of the present disclosure, the client devices 110 and servers 130 may be implemented using a computer system 1000 in response to processor 1002 executing one or more sequences of one or more instructions contained in memory 1004. Such instructions may be read into memory 1004 from another machine-readable medium, such as data storage device 1006. Execution of the sequences of instructions contained in memory 1004 causes processor 1002 to perform the process steps described herein. One or more processors in a multi-processing arrangement may also be employed to execute the sequences of instructions contained in memory 1004. In alternative aspects, hard-wired circuitry may be used in place of or in combination with software instructions to implement various aspects of the present disclosure. Thus, aspects of the present disclosure are not limited to any specific combination of hardware circuitry and software.

Various aspects of the subject matter described in this specification may be implemented in a computing system that includes a back-end component, e.g., a data server, or that includes a middleware component, e.g., an application server, or that includes a front-end component, e.g., a client computer having a graphical user interface or a Web browser through which a user may interact with an implementation of the subject matter described in this specification, or any combination of one or more such back-end, middleware, or front-end components. The components of the system may be interconnected by any form or medium of digital data communication, e.g., a communication network. The communication network (e.g., network 150) may include, for example, any one or more of a LAN, a WAN, the Internet, and the like. Further, the communication network may include, but is not limited to, for example, any one or more of the following tool topologies, including a bus network, a star network, a ring network, a mesh network, a star-bus network, tree or hierarchical network, or the like. The communications modules may be, for example, modems or Ethernet cards.

Computer system 1000 may include clients and servers. A client and server may be generally remote from each other and typically interact through a communication network. The relationship of client and server arises by virtue of computer programs running on the respective computers and having a client-server relationship to each other. Computer system 1000 may be, for example, and without limitation, a desktop computer, laptop computer, or tablet computer. Computer system 1000 may also be embedded in another device, for example, and without limitation, a mobile telephone, a PDA, a mobile audio player, a Global Positioning System (GPS) receiver, a video game console, and/or a television set top box.

The term “machine-readable storage medium” or “computer-readable medium” as used herein refers to any medium or media that participates in providing instructions to processor 1002 for execution. Such a medium may take many forms, including, but not limited to, non-volatile media, volatile media, and transmission media. Non-volatile media include, for example, optical or magnetic disks, such as data storage device 1006. Volatile media include dynamic memory, such as memory 1004. Transmission media include coaxial cables, copper wire, and fiber optics, including the wires forming bus 1008. Common forms of machine-readable media include, for example, floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH EPROM, any other memory chip or cartridge, or any other medium from which a computer may read. The machine-readable storage medium may be a machine-readable storage device, a machine-readable storage substrate, a memory device, a composition of matter affecting a machine-readable propagated signal, or a combination of one or more of them.

To illustrate the interchangeability of hardware and software, items such as the various illustrative blocks, modules, components, methods, operations, instructions, and algorithms have been described generally in terms of their functionality. Whether such functionality is implemented as hardware, software, or a combination of hardware and software depends upon the particular application and design constraints imposed on the overall system. Skilled artisans may implement the described functionality in varying ways for each particular application.

### General Notes on Terminology

As used herein, the phrase “at least one of” preceding a series of items, with the terms “and” or “or” to separate any of the items, modifies the list as a whole, rather than each member of the list (i.e., each item). The phrase “at least one of” does not require selection of at least one item; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

To the extent that the term “include,” “have,” or the like is used in the description or the claims, such term is intended to be inclusive in a manner similar to the term “comprise” as “comprise” is interpreted when employed as a transitional word in a claim. The word “exemplary” is used herein to mean “serving as an example, instance, or illustration.” Any embodiment described herein as “exemplary” is not necessarily to be construed as preferred or advantageous over other embodiments.

A reference to an element in the singular is not intended to mean “one and only one” unless specifically stated, but rather “one or more.” All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description. No clause element is to be construed under the provisions of 35 U.S.C. § 112, sixth paragraph, unless the element is expressly recited using the phrase “means for” or, in the case of a method clause, the element is recited using the phrase “step for.”

While this specification contains many specifics, these should not be construed as limitations on the scope of what may be claimed, but rather as descriptions of particular implementations of the subject matter. Certain features that are described in this specification in the context of separate embodiments may also be implemented in combination in a single embodiment. Conversely, various features that are described in the context of a single embodiment may also be implemented in multiple embodiments separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

The subject matter of this specification has been described in terms of particular aspects, but other aspects may be implemented and are within the scope of the following claims. For example, while operations are depicted in the drawings in a particular order, this should not be understood as requiring that such operations be performed in the particular order shown or in sequential order, or that all illustrated operations be performed, to achieve desirable results. The actions recited in the claims may be performed in a different order and still achieve desirable results. As one example, the processes depicted in the accompanying figures do not necessarily require the particular order shown, or sequential order, to achieve desirable results. In certain circumstances, multitasking and parallel processing may be advantageous. Moreover, the separation of various system components in the aspects described above should not be understood as requiring such separation in all aspects, and it should be understood that the described program components and systems may generally be integrated together in a single software product or packaged into multiple software products. Other variations are within the scope of the following claims.

What is claimed is:

1. A computer-implemented method, comprising:
receiving, from a client device, one or more images of a user of the client device;
determining a target appearance of an avatar of the user;
generating, based on the one or more images of the user and based on the target appearance of the avatar, a plurality of renders of the avatar;
determining, based on a difference between a first render and a second render of the plurality of renders, a first adjustment to a weight associated with a first parameter for generating the plurality of renders and a second adjustment to a weight associated with a second parameter for generating the plurality of renders; and
generating, based on the first adjustment and the second adjustment, a third render of the avatar, the third render appearing more similar to the target appearance relative to the first render and the second render.

2. The computer-implemented method of claim 1, further comprising extracting, from the one or more images of the user, a face of the user.

3. The computer-implemented method of claim 1, further comprising generating, from the one or more images of the user, the avatar of the user.

4. The computer-implemented method of claim 1, wherein determining the target appearance for the avatar of the user includes receiving, from the client device, the target appearance by at least one of text and images.

5. The computer-implemented method of claim 1, wherein the first parameter includes a geometry parameter and the second parameter includes a texture parameter.

6. The computer-implemented method of claim 1, further comprising determining, based on a loss, the difference between the first render and the second render of the plurality of renders.

7. The computer-implemented method of claim 6, wherein:
the loss includes a direction loss between a source domain associated with an original render of the avatar and a target domain associated with the target appearance of the avatar; and
the plurality of renders differ from the original render only along a target direction from the source domain to the target domain.

8. The computer-implemented method of claim 1, further comprising determining a regularizer to preserve one or more key facial features of the user between the first render and the second render.

9. The computer-implemented method of claim 8, wherein the regularizer preserves spatial layout, shape, and perceived semantics between the first render and the second render.

10. The computer-implemented method of claim 1, further comprising determining a regularizer to reduce asymmetrical artifacts around eyes of the avatar between the first render and the second render.

11. A system, comprising:
one or more processors; and
a memory storing instructions which, when executed by the one or more processors, cause the system to:
receive, from a client device, one or more images of a user of the client device;
determine a target appearance of an avatar of the user;
generate, based on the one or more images of the user and based on the target appearance of the avatar, a plurality of renders of the avatar;
determine, based on a difference between a first render and a second render of the plurality of renders, a first adjustment to a weight associated with a first parameter for generating the plurality of renders and a second adjustment to a weight associated with a second parameter for generating the plurality of renders; and
generate, based on the first adjustment and the second adjustment, a third render of the avatar, the third render appearing more similar to the target appearance relative to the first render and the second render.

12. The system of claim 11, wherein the one or more processors are further configured to extract, from the one or more images of the user, a face of the user.

13. The system of claim 11, wherein the one or more processors are further configured to generate, from the one or more images of the user, the avatar of the user.

14. The system of claim 11, wherein determining the target appearance for the avatar of the user includes receiving, from the client device, the target appearance by at least one of text and images.

15. The system of claim 11, wherein the first parameter includes a geometry parameter and the second parameter includes a texture parameter.

16. The system of claim 11, wherein the one or more processors are further configured to determine, based on a loss, the difference between the first render and the second render of the plurality of renders.

17. The system of claim 16, wherein:
the loss includes a direction loss between a source domain associated with an original render of the avatar and a target domain associated with the target appearance of the avatar; and
the plurality of renders differ from the original render only along a target direction from the source domain to the target domain.

18. The system of claim 11, wherein the one or more processors are further configured to determine a regularizer to preserve one or more key facial features of the user between the first render and the second render, wherein the regularizer preserves spatial layout, shape, and perceived semantics between the first render and the second render.

19. The system of claim 11, wherein the one or more processors are further configured to determine a regularizer to reduce asymmetrical artifacts around eyes of the avatar between the first render and the second render.

20. A non-transient computer-readable storage medium having instructions embodied thereon, the instructions being executable by one or more processors to perform a method, the method including:
receiving, from a client device, images of a user of the client device;
determining a target appearance of an avatar of the user;
generating, based on the one or more images of the user and based on the target appearance of the avatar, a plurality of renders of the avatar;
determining, based on a loss, a difference between a first render and a second render of the plurality of renders;
determining a first regularizer to preserve one or more key facial features of the user between the first render and the second render, wherein the first regularizer preserves spatial layout, shape, and perceived semantics between the first render and the second render;
determining a second regularizer to reduce asymmetrical artifacts around eyes of the avatar between the first render and the second render;
determining, based on the difference, the first regularizer, and the second regularizer, a first adjustment to a weight associated with a first parameter for generating the plurality of renders and a second adjustment to a weight associated with a second parameter for generating the plurality of renders; and
generating, based on the first adjustment and the second adjustment, a third render of the avatar, the third render appearing more similar to the target appearance relative to the first render and the second render.
